(19) United States
(12) Patent Application Publication
(10) Pub. No.: US 2001/0035167 A1
(43) Pub. Date: Nov. 1, 2001

(54) High-pressure injection system for diesel engines and method of operating same

(76) Inventor: Volker Schwarz, Weinstadt (DE)

Correspondence Address: EVENSON, McKEOWN, EDWARDS & LENAHAN, P.L.L.C., Suite 700, 1200 G Street, N.W., Washington, DC, 20005, US

(21) Appl. No.: 09/811,782

(22) Filed: Mar. 20, 2001

(30) Foreign Application Priority Data
Mar. 20, 2000 (DE) 100 13 538.2-13

(51) Int. Cl. F02M 37/04

(52) U.S. Cl. 123/495; 123/499

(57) ABSTRACT

A high-pressure injection system for internal combustion engines, in particular diesel engines, operates with an actuating force superimposed on a spring force which loads a nozzle needle in the closing direction. The high-pressure injection system operates in such a way that the pressure profile which occurs over the injection stroke of the pump and the resulting injection profile is varied by the actuating force.

### BACKGROUND AND SUMMARY OF THE INVENTION

This application claims the priority of German Patent Document 100 13 538.2, filed in Germany, Mar. 20, 2000, the disclosure of which is expressly incorporated by reference herein.

The invention relates to a high-pressure injection system for internal combustion engines. Preferred embodiments of the invention relate to a high-pressure injection system for internal combustion diesel engines comprising a pump unit and an injection nozzle which is connected by line to the pump unit, said injection nozzle being assigned to a cylinder combustion space and having a closing phase and an opening phase determined by actuation of the pump, said injection nozzle having an injection opening which is controlled by a nozzle needle which is spring-loaded in a closing direction and can be moved for the purpose of injection out of its closed position held by spring force and is acted on in an opening direction in an opening phase by the pump unit with fuel which is supplied under pressure and in a timed and cylinder-specific fashion.

High-pressure injection systems of the abovementioned type are known in practice, for example, as so-called pump line nozzle injection systems, and can also be found in German Patent Document DE 44 41 603 A1. So-called cartridge-type pumps are usually used as the pump unit here, one such pump being assigned in each case to a nozzle and its drive being branched off from a control camshaft which, for this purpose, is fitted with appropriate pump cams in addition to the inlet and/or outlet cams for the associated valves.

The use of separate pump units which are respectively assigned to a cylinder combustion space or the injection nozzle which is associated therewith in each case makes it possible to place said pump units near to the respective injection nozzles so that only short line routes are required, which makes it possible to operate with higher pressures. Furthermore, owing to their electronic actuation, such pump units also permit different injection characteristics to be implemented.

Functionally, the respective pump unit generates a pressure wave which propagates through the injection line to the injection nozzle. If its opening pressure is exceeded, said opening pressure being determined by the prestressing of a spring and being invariable during operation, the injection nozzle opens as a result of the nozzle needle lifting off from the injection opening controlled by the nozzle needle, at which time the injection begins. The injection is ended by the opening of a control valve which is associated with the pump unit and which leads to a rapid pressure drop in the nozzle with the result that the nozzle needle can be forced back into its closed position by the spring force.

In such a pump unit, a virtually triangular pressure profile is obtained at the injection opening or the injection holes forming said opening, and the level of the injection pressure cannot be varied for a defined load/rotational speed point during the operation of the internal combustion engine. In particular, owing to the abovementioned triangular pressure profile with relatively flat rise and steep drop, preinjection can be implemented only with difficulty, while post-injection with a high injection pressure is not possible.

An object of the invention is to provide further possibilities of influencing essential injection parameters in a high-pressure injection system of the type mentioned at the beginning so that, for example by selecting the opening and closing pressure of the nozzle, it is possible to optimize said nozzle in terms of fuel consumption or emissions for the respective operating range of the internal combustion engine, or else implement preinjection and/or post-injection operations.

This object is achieved according to preferred embodiments of the invention by providing that the nozzle needle can be acted on in the opening phase, in the direction of the spring force by an additional actuation force which is variable over the injection profile.

According to preferred embodiments of the invention, the force loading the nozzle needle in the closing direction is variable, variability in this respect being expedient in particular in the opening phase which is possible as a function of the magnitude and length of the pressure wave emerging from the pump unit, which is to be understood to mean that the overall force acting in the direction of the spring force can be influenced within the scope of the invention both in terms of the opening time and in terms of the closing time of the injection. In particular, the variability of the spring force and/or of the force superimposed on the spring force can also influence the injection profile to the extent that the latter is decomposed, as appropriate, into individual sectors, for example into preinjection and main injection, into main injection and post-injection or else into preinjection, main injection and post-injection. The variability of the actuating force can be obtained within the scope of the invention by changing the spring characteristic or else by an actuating force which acts in addition to the spring force and can be superimposed on the spring force.

The changing of the spring force is preferably possible within the scope of the invention by virtue of the fact that the spring which acts in the closing direction of the nozzle needle and acts on the nozzle needle is supported at the housing end in an adjustable way. An application of force superimposed on the spring force is possible, for example, by virtue of the fact that, in addition to the spring, the nozzle needle is acted on by a corresponding actuating force.

In the scope of the invention, different actuating means are appropriate for applying the actuating force, for example actuating magnets, electromechanical actuating devices such as piezoelements or the like. In addition, the actuating force can also be applied hydraulically.

In particular, the supporting of the spring at the housing end can be adjusted in the direction of the spring axis for example by high-speed switching piezoelements with small dimensions.

According to certain preferred embodiments of the invention, a particularly expedient possible way of applying a superimposed additional actuating force acting in the closing direction of the nozzle needle consists in the fact that, in the opening phase, the nozzle needle can be acted on, superimposed on the spring force, by means of the fuel supplied by the pump.

It proves expedient according to certain preferred embodiments of the invention to assign a control piston to the nozzle needle and to use the excess portion of fuel which is supplied by the pump and is under high pressure, that is to say the non-injected portion of the supplied quantity of fuel, as a pressure means by means of which the control piston is acted on its rear side facing away from the injection nozzle. It proves expedient here to throttle the branching onto the return, in particular, however, to throttle, in a controlled fashion, the return flow as it flows out of the nozzle space receiving the control piston, with the result that the application of pressure to the control piston can be varied and as a result, in the way described, the closing force of the nozzle needle can be influenced as a supplement to the nozzle spring. The outflow throttle can be formed easily by means of a solenoid valve with a ball seat.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic view of a pump line nozzle for an injection system of an internal combustion engine which is not illustrated here in more detail, constructed according to preferred embodiments of the invention;

FIG. 2 shows a schematic view of the nozzle, the nozzle being embodied in order to provide hydraulically controllable amplification of the actuating force by means of which the nozzle needle is loaded in the direction of its closing position, to be precise with the injection opening of the nozzle closed by means of the nozzle needle;

FIG. 3 shows a view corresponding to FIG. 2 with the injection opening opened; and

FIG. 4 shows a diagrammatic view of the line pressure downstream of the cartridge-type pump, of the injection profile which is divided into preinjection and main injection, and of the actuation current, corresponding to this injection profile, of the solenoid valve for the outflow throttle located in the return.

### DETAILED DESCRIPTION OF THE DRAWINGS

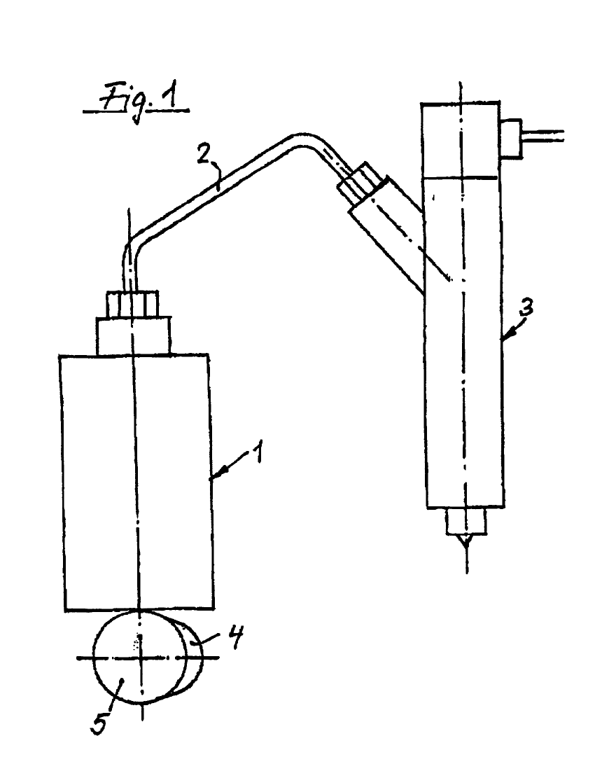

FIG. 1 shows a schematic view of a high-pressure injection system for an internal combustion engine, in particular a diesel engine, where the rest of the internal combustion engine is not illustrated. The high-pressure injection system is embodied in the exemplary embodiment as a pump line nozzle system, the pump being designated by 1, the line by 2 and the nozzle by 3. The pump 1 is embodied as a so-called cartridge-type pump, the drive for the pump 1 being provided by means of the cam 4 of a camshaft 5, which, as a control camshaft for charge cycle valves of the internal combustion engine, is also fitted (in a way not illustrated here) with cams which act on said valves.

In the embodiment illustrated here, the pump 1 forms a pump unit which is assigned to just one nozzle 3 so that it is possible to place the pump 1 in a close relationship with the nozzle 3, and thus implement very short and rigid line paths, as illustrated by means of the line 2.

Correspondingly, in a high-pressure injection system of the type shown, very high line pressures can be implemented which reach the range of well above 1,000 bar, namely approximately 1,600-1,800 bar at the peak, it being possible, as illustrated in FIG. 4, to implement a triangular pressure profile with a generally somewhat flatter rise and steeper drop with a maximum pressure in the vicinity of the end of the injection, which proves expedient in terms of achieving low fuel consumption. Irrespective of the electronic control of the pump, the injection pressure which it is used to produce is dependent on the rotational speed and load, and a pressure wave is transmitted to the nozzle 3 by means of the pump 1 and the line 2, it being impossible to implement any suitable preinjection or post-injection starting from the pump 1, nor is it possible to deform the injection profile.

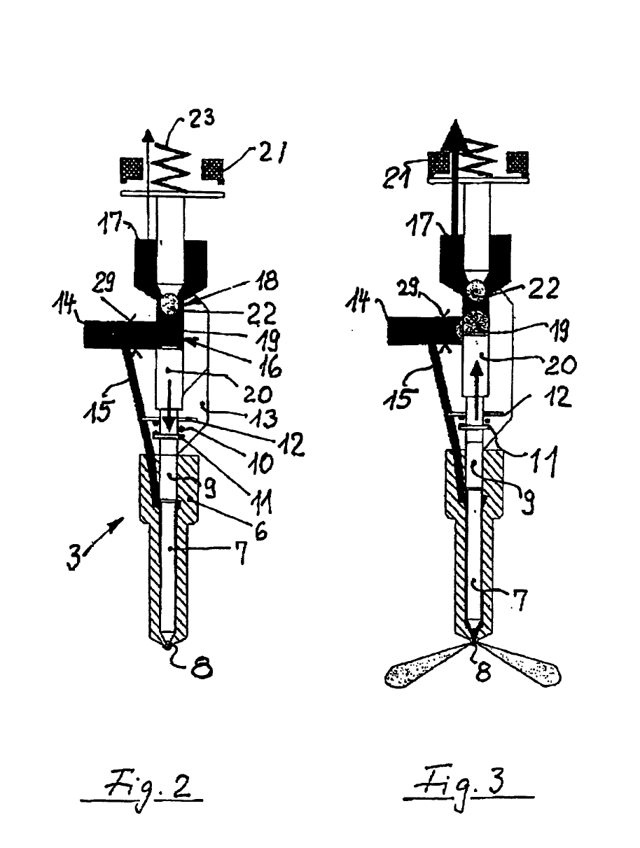

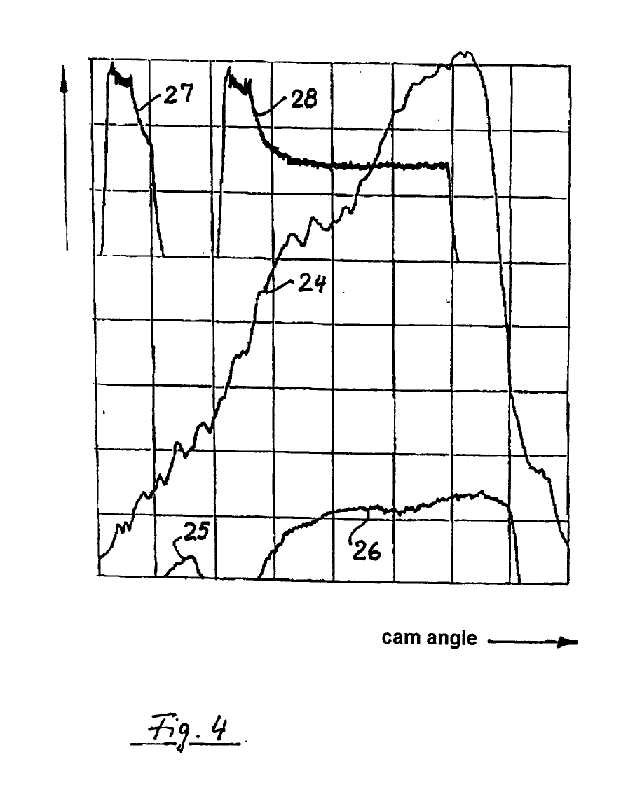

The nozzle 3 shows, as illustrated schematically in FIGS. 2 and 3, a known basic design with a nozzle needle 7 guided in the nozzle body 6 and an injection opening 8 which is controlled by the nozzle needle 7, opens into the combustion space (not illustrated) of the internal combustion engine and is provided in the nozzle body 6. The nozzle needle 7 is adjoined by a pressure linkage 9 which lies coaxially with respect to the nozzle needle and which is loaded in the closing direction of the nozzle needle 7 by a nozzle spring 10, the nozzle spring 10 being arranged between a stop 11 which is associated with the pressure linkage 9 and a stop 12 which is supported against the nozzle housing 13 (only indicated), with the result that the nozzle needle 7 is loaded in the closing direction by the nozzle spring 10.

With such a basic design, the loading of the nozzle needle 7 by the nozzle spring 10 is determined by the prestressing of the spring and is not variable during operation.

The connection to the pump 1 is not illustrated in more detail in FIGS. 2 and 3, and the line 2 coming from the pump 1 opens at the nozzle end into the high-pressure inflow 14 from which a branching line 15, which is integrated into the nozzle 3, leads to the nozzle needle 7, in such a way that the fuel which is supplied via the branching line and is under pressure passes along the nozzle needle 7, between the latter and the nozzle body 6, into the region of the injection opening 8. Here a pressure builds up in accordance with the intermittent feeding by the pump unit 1 which is embodied as a cartridge-type piston pump and the pressure wave which it is used to generate, said pressure having to be large enough to open an injection opening 8 so that the nozzle needle lifts off counter to the loading by the nozzle spring 10, as illustrated in FIG. 3. An injection then takes place. The injection profile is thus dependent, in terms of this basic design of the nozzle, on the profile of the pressure wave which starts from the pump 1, and the configuration and prestressing of the nozzle spring 10.

Within the scope of the invention, a refinement is provided by means of which the pressure at which the nozzle opens during the operation of the internal combustion engine can be varied. The variation is possible by virtue of the fact that the pressure wave generated by the pump is modulated appropriately in terms of its effect on the nozzle needle 7 and/or also by virtue of the fact that the prestressing of the nozzle needle 10 is changed.

FIGS. 2 and 3 illustrate an exemplary embodiment in which the pressure wave is modulated in terms of its effect on the nozzle needle 7 by virtue of the fact that the high pressure inflow 14 has, at the nozzle end, a branch 16 to a leakage-quantity return 17, the fluid passing to the leakage-quantity return via a controlled outflow throttle 18. An inflow throttle 29 is preferably arranged upstream of the outflow throttle 18 in the branch 16 to the leakage-quantity return 17, and the branch 16 is connected to a nozzle space 19 into which a guide hole for a control piston 20 opens. The control piston 20 is located, as part of the pressure linkage 9, preferably in a coaxial orientation with respect to the pressure linkage 9 and nozzle needle 7, and the pressure space 19 is expediently formed by an extension of the receiving hole for the control piston 20, the outflow throttle 18 being also preferably oriented coaxially with respect to the nozzle axis. The outflow nozzle 18 is expediently controlled by means of a solenoid valve 21 which acts on a corresponding blocking ball 22 which is assigned a corresponding ball seat in the junction between the branch 16 and the return 17. Within the scope of the invention, the blocking ball 22 is preferably spring-loaded in the direction of its blocking position. The corresponding spring is designated by 23.

If, as illustrated in FIG. 2, the junction to the leakage-quantity return 17 is blocked by means of the outflow throttle 18, owing to the configuration of the prestressing of the nozzle spring 10 and of the pressure faces acted on by the control piston 20 and the nozzle needle 7, in terms of the ratio of said pressure faces to one another, the nozzle needle 7 is held in its closed position. In the blocking position of the outflow throttle 18, the solenoid valve 21 is de-energized and the blocking ball 22 is prestressed in the direction of its blocking position by means of the spring 23. The passage to the leakage-quantity return 17 is at least essentially blocked.

Because the pressure wave generated at the pump end cannot force away the nozzle needle 7 into an opening position counter to the force of the spring 10 and of the pressure application of the control piston 20, owing to the loading ratios described, the injection characteristics of the nozzle 3 are controlled by means of the controlling of the leakage-quantity return flow.

FIG. 3 shows the outflow throttle 18 in the opened state, i.e. with the solenoid valve 21 energized and the blocking ball 22 lifted off counter to the force of the spring 23, with the result that the pressure in the pressure space 19 is reduced to such an extent that the pressure loading acting on the nozzle needle 7 via the pressure wave of the pump 1 counter to the force of the nozzle spring 10 lifts off the nozzle needle 7 from the injection opening 8 and thus releases the injection.

Instead of the nozzle needle 7 or the control piston 20 being acted on hydraulically with the superimposition of the force of the nozzle spring 10 (illustrated in FIGS. 2 and 3), it is also contemplated within the scope of the invention to change the spring characteristic curve of the nozzle spring 10, for example by virtue of the fact that the housing-end stop 12 is supported in an appropriately adjustable way, for example by means of piezoelements, which are electrically actuated in order to vary the spring characteristic curve or the opening pressure or closing pressure.

This is also possible hydraulically by using an appropriate piston element, in which case the actuating force acting on the piston could be applied in a way analogous to the solution shown in FIG. 3.

FIG. 4 illustrates how the solution according to the invention permits, with respect to a triangular line pressure profile relating to the cam angle after the cartridge-type pump—curve 24, a specific configuration of the injection profile relating to the cam angle—curves 25 and 26, 25 illustrating a preinjection and 26 illustrating a main injection, and this being achieved by appropriately energizing the solenoid valve 21, which is illustrated in the curve lines 27 and 28 plotted against the cam angle, the curve line 27 being assigned to the preinjection 25 and the curve line 28 being assigned to the main injection 26. The pressure wave supplied by the pump 1 is thus modulated, within the scope of the injection without significant supplementary expenditure as illustrated by the schematic views according to FIGS. 2 and 3, in its effect on the opening state of the nozzle 3 in such a way that an injection profile which is briefly interrupted is obtained. Instead of the preinjection and main injection illustrated in the example in FIG. 4, it is also contemplated, as appropriate, to implement a main injection and a post-injection or preinjection, main injection and post-injection in that a counter-force is superimposed over the profile of the pressure wave of the force acting continuously as a function of pressure in the opening direction of the nozzle needle 7, said counter-force being pressure-dependent as a function of the opened state and closed state of the solenoid valve 21 and acts in the same direction as the spring force 10 in such a way that the nozzle is closed when the solenoid valve is closed and there is a corresponding application of pressure to the control piston 20, but the nozzle needle 7 is forced into its open position when the solenoid valve 21 is energized and the outflow to the return line 17 is released.

The invention relates to a high-pressure injection system for internal combustion engines, in particular diesel engines, which operates with an actuating force superimposed on the spring force which loads the nozzle needle in the closing direction, said high-pressure injection system operating in such a way that the pressure profile which is produced over the injection stroke of the pump and the resulting injection profile can be varied by means of the actuating force.

The invention also relates, of course, to a method for operating a high-pressure injection system described above, as becomes apparent from the processes described.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. High-pressure injection system for internal combustion diesel engines comprising:
1 a pump unit and an injection nozzle which is connected by line to the pump unit, said injection nozzle being assigned to a cylinder combustion space and having a closing phase and an opening phase determined by actuation of the pump, said injection nozzle having an injection opening which is controlled by a nozzle needle which is spring-loaded in a closing direction and can be moved for the purpose of injection out of its closed position held by spring force and is acted on in an opening direction in an opening phase by the pump unit with fuel which is supplied under pressure and in a timed and cylinder-specific fashion,
wherein the nozzle needle can be acted on in the opening phase, in the direction of the spring force by an additional actuation force which is variable over the injection profile.

2. High-pressure injection system according to claim 1, wherein the actuation force is applied by an actuator magnet.

3. High-pressure injection system according to claim 1, wherein the actuation force is applied electromechanically.

4. High-pressure injection system according to claim 1, wherein the actuation force is applied by a piezoelement.

5. High-pressure injection system according to claim 1, wherein the actuation force is applied hydraulically.

6. High-pressure injection system according to claim 5, wherein the nozzle needle can be acted on in the opening phase by the fuel supplied by the pump unit superimposed on the spring force.

7. High-pressure injection system according to claim 6, wherein the nozzle needle can be acted on, superimposed on the spring force, by a portion of the fuel supplied by the pump unit which is branched off from the feed line in a direction of a fuel return.

8. High-pressure injection system according to claim 7, wherein the portion of fuel which is branched off from the feed line to the nozzle and supplied to the return by acting on the nozzle needle is branched off in a throttled fashion.

9. High-pressure injection system according to claim 7, wherein the passing of the fuel portion which is branched off from the pump supply and acts on the nozzle needle to the leakage-quantity return is controlled by means of a throttle.

10. High-pressure injection system according to claim 8, wherein the passing of the fuel portion which is branched off from the pump supply and acts on the nozzle needle to the leakage-quantity return is controlled by means of a throttle.

11. High-pressure injection system according to claim 9, wherein the outflow throttle is controlled by means of a solenoid valve.

12. High-pressure injection system according to claim 10, wherein the outflow throttle is controlled by means of a solenoid valve.

13. High-pressure injection system according to claim 11, wherein the outflow throttle has a ball seat controlled by means of the solenoid valve.

14. High-pressure injection system according to claim 12, wherein the outflow throttle has a ball seat controlled by means of the solenoid valve.

15. High-pressure fuel injection system for an internal combustion engine comprising:
an injection nozzle which in use opens to an engine combustion space, said injection nozzle including a nozzle needle controlling an injection opening as a function of fuel pressure applied thereto,
high pressure fuel supply means operable to supply fuel to the injection nozzle under pressure conditioning as a function of engine operations, and
additional actuation force means operable to modulate movement of the injection nozzle by applying a variable actuation force on the nozzle during injection operations.

16. High-pressure fuel injection system according to claim 15, wherein the injection nozzle includes a closing spring biasing the nozzle needle toward a closed position of the injection opening, and
wherein fuel pressure applied by the high pressure fuel supply means acts on the nozzle needle in a direction opposing the closing spring.

17. High-pressure fuel injection system according to claim 16, wherein the additional actuation force means includes pressure relief means for relieving fuel pressure acting on the nozzle needle.

18. High-pressure fuel injection system according to claim 16, wherein the additional actuating force means includes an actuator magnet.

19. High-pressure fuel injection system according to claim 16, wherein the additional actuating force means includes an electromechanical device.

20. High-pressure fuel injection system according to claim 16, wherein the additional actuating force means includes a piezoelement.

21. A method of operating a fuel injection nozzle which in use opens to a vehicle combustion space and includes a fuel supply pressure actuated injection needle which is biased towards a closed position, said method comprising superimposing a variable actuator force on the injection needle to vary the opening position of the needle over an injection profile.

22. A method according to claim 21, wherein said superimposing a variable actuation force includes relieving pressure of fuel supplied to the needle.
